(19) United States
(12) Patent Application Publication
(10) Pub. No.: US 2022/0058827 A1
(43) Pub. Date: Feb. 24, 2022

(54) MULTI-VIEW ITERATIVE MATCHING POSE ESTIMATION

(71) Applicants: Hewlett-Packard Development Company, L.P., Spring, TX (US); Purdue Research Foundation, West Lafayette, IN (US)

(72) Inventors: Daniel Mas Montserrat, Palo Alto, CA (US); Qian Lin, Palo Alto, CA (US); Edward J. Delp, West Lafayette, IN (US); Jan Allebach, West Lafayette, IN (US)

(73) Assignees: Hewlett-Packard Development Company, L.P., Spring, TX (US); Purdue Research Foundation, West Lafayette, IN (US)

(21) Appl. No.: 17/312,194

(22) PCT Filed: Mar. 29, 2019
(86) PCT No.: PCT/US2019/025059

§ 371 Date: Jun. 9, 2021

(51) Int. Cl. G06T 7/73

(52) U.S. Cl. CPC G06T 7/75; G06T 2207/20081; G06T 2207/20084

(57) ABSTRACT

A pose estimation system may be embodied as hardware, firmware, software, or combinations thereof to receive an image of an object. The system may determine a first pose estimate of the object via a multi-view matching neural network and then determine a final pose estimate of the object via analysis by an iteratively-refining single-view matching neural network.

### BACKGROUND

Augmented reality systems and other interactive technology systems use information relating to the relative location and appearance of objects in the physical world. Computer vision tasks can be subdivided into three general classes of methodologies, including analytic and geometric methods, genetic algorithm methods, and learning-based methods.

### BRIEF DESCRIPTION OF THE DRAWINGS

The written disclosure herein describes illustrative examples that are nonlimiting and non-exhaustive. Reference is made to certain of such illustrative examples that are depicted in the figures described below.

FIG. 1 illustrates an example of a pose estimation system.

FIG. 2 illustrates a printer as an example of an object with three-axis rotation parameters pitch, roll, and yaw.

FIG. 3 illustrates a conceptual block diagram of a workflow for pose estimation.

FIG. 4A illustrates an example block diagram of a single-view convolutional neural network that includes various flownet convolutional layers and linear layers to determine rotation and translation pose parameters.

FIG. 4B illustrates an example block diagram of another single-view convolutional neural network that includes various flownet convolutional layers and linear layers to determine rotation, translation, and angle distance pose parameters.

FIG. 5 illustrates a block diagram of an example workflow of the single-view convolutional neural network.

FIG. 6 illustrates a block diagram of a multi-view convolutional neural network with six flownets corresponding to six different views of an object.

FIG. 7A illustrates a flow diagram 700 of an example workflow for pose estimation.

FIG. 7B illustrates a flow diagram of an example workflow for pose estimation and tracking.

### DETAILED DESCRIPTION

A processor-based pose estimation system may use electronic or digital three-dimensional models of objects to train a neural network, such as a convolutional neural network (CNN), to detect an object in a captured image and determine a pose thereof. Systems and methods are described herein for a three-stage approach to pose estimation that begins with object detection and segmentation. Object detection and segmentation can be performed using any of a wide variety of approaches and techniques. Examples of suitable object detection and/or segmentation systems include those utilizing various recursive CNN (R-CNN) approaches, such as Faster R-CNN, Mask R-CNN, convolutional instance-aware semantic segmentation, or another approach known in the art.

The pose estimation system may receive an image of the object and determine an initial pose via a multi-view matching subsystem (e.g., a multi-view matching neural network). The pose estimation system may refine the initial pose through iterative (e.g., recursive) single-view matching. The single-view matching system may receive the initial pose from the multi-view matching network and generate a first refined pose. The refined pose may be processed via the single-view matching network again to generate a second refined pose that is more accurate than the first refined pose.

The pose estimation system may continue to refine the pose via the single-view matching network any number of times or until the difference between the two most recently generated refined poses are sufficiently similar. The single-view matching network may stop the refinement process as being completed when the estimated rotation angle (as estimated by the single-view matching network) is below a threshold. In some examples, a pose estimation system is computer-based and includes a processor, memory, computer-readable medium, input devices, output devices, network communication modules, and/or internal communication buses.

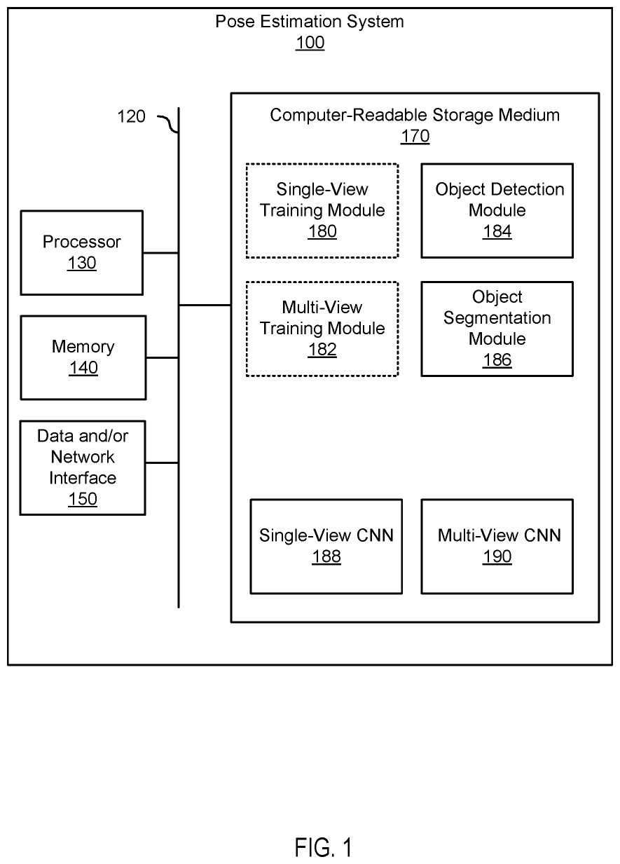

FIG. 1 illustrates an example of a pose estimation system 100 that includes a processor 130, a memory 140, a data and/or network interface 150, and a computer-readable medium 170 interconnected via a communication bus 120. The computer-readable medium 170 include all or some of the illustrated modules 180-190. The modules may be implemented using hardware, firmware, software and/or combinations thereof. In other examples, the modules may be implemented as hardware systems or subsystems outside of the context of a computer-readable medium. Software implementations may be implemented via instructions or computer code stored on a non-transitory computer-readable medium.

A single-view matching network training module 180 may be used to train a or “build” a network, such as a flownet backbone or just “flownet,” for a single-view CNN 188. Each layer of each of the single-view and multi-view network is trained. For instance, the single-view and multi-view networks may include the ten first layers of FlowNetS or another combination of any set of convolutions of another FlowNet-type. The single-view and multi-view networks may also include additional fully-connected layers and regressors. Accordingly, the training module 180 may train the flownet layers, fully-connected layers, and regressors.

The single-view CNN 188 is trained to determine pose difference parameters between (i) a pose of an object in a target image or target pose of a rendered object and (ii) a pose of a reference or most recently rendered object. A multi-view matching network training module 182 may train or “build” a plurality of networks, such as flownets, for a multi-view CNN 190, for each of a corresponding plurality of views of the object. For example, six flownets, or other convolutional neural networks, may be trained for six views of an object. The six views of the object may include, for example, a frontal view, a first lateral view, an opposing lateral view, a top view, a bottom view, and a back view. Since the single-view flownet and the multi-view flownets are trained using views of the same object, many of the weights and processing parameters can be shared between the neural networks. The multi-view and single-view networks are trained to estimate pose differences and so the filters and/or weights “learned” for the single-view network are useful for the multi-view networks as well.

In some examples, the single-view CNN may be trained first and the filters and weights learned during that training may be used as a starting point for training the networks of the multi-view CNN. In other examples, the single-view CNN and the multi-view CNN may be concurrently trained end-to-end.

Concurrent end-to-end training of the single-view CNN and multi-view CNN may begin with an initial pose estimate using the multi-view CNN. The angle error of the initial pose estimate is evaluated and, if it is less than a training threshold angle (e.g., 25°), it is used as a training sample of the single view CNN. If, however, the angle error of the initial pose estimate is evaluated and determined to be greater than the training threshold angle (in this example, 25°) then a new random rotation close to the real pose (i.e., ground truth). The new random rotation close to the real pose is then used as a training sample for the single-view CNN.

In early stages of the concurrent end-to-end training, it is likely that the initial pose estimates of the multi-view CNN will not be accurate, and the angle error will likely exceed the training threshold angle (e.g., a training threshold angle between 15° and 35°, such as 25°). During these early stages, the generation of a new, random rotation of a pose close to the real pose eases the training process of the single-view CNN. In later stages of the concurrent end-to-end training, the accuracy of the initial pose estimates of the multi-view CNN will increase, and the initial pose estimates from the multi-view CNN can be used as a training sample for the single-view CNN.

Using the initial pose estimates (that satisfy the training threshold error angle) from the multi-view CNN to train the single-view CNN, allows the single-view CNN to be trained to fix errors caused by the multi-view CNN. In such examples, the single-view CNN is trained to fix latent or trained errors in the multi-view CNN. The concurrent end-to-end training provides a training environment that corresponds to the workflow in actual deployment.

Each flownet may include a network that calculates optical flow between two images. As used herein, the term flownet can include other convolutional neural networks trained to estimate the optical flow between two images, in addition to or instead of traditional flownet. Flownets may include variations, adaptations, and customizations of FlowNet1.0, FlowNetSimple, FlowNetCorr, and the like. As used herein, the term flownet may encompass an instantiation of one of these specific convolutional architectures, or a variation or combination thereof. Furthermore, the term flownet is understood to encompass stacked architectures of more than one flownet.

Training of the single-view and multi-view networks may be completed for each object for which the pose estimation system 100 will process. The single-view training module 180 and multi-view training module 182 are shown with dashed lines because, in some examples, these modules may be excluded or removed from the pose estimation system 100 once the single-view CNN 188 and multi-view CNN 190 are trained. For example, the single-view training module 180 and multi-view training module 182 may be part of a separate system that is used to initialize or train the pose estimation system 100 prior to use or sale.

Once training is complete, an object detection module 184 of the pose estimation system 100 may, for example, use a Mask R-CNN to detect a known object (e.g., an object for which the pose estimation system 100 has been trained) in a captured image received via the data and/or network interface 150. An object segmentation module 186 may segment the detected object in the captured image. The multi-view CNN 190 may match the detected and segmented object in the captured image through a unique flownet for each view of the multi-view CNN 190 (also referred to herein as a multi-view matching CNN). The multi-view CNN 190 may determine an initial pose estimate of the detected and segmented object for further refinement by the single-view CNN 188.

The single-view CNN 188 iteratively refines the initial pose estimate and may be aptly referred to as an iteratively-refining single-view CNN. The single-view CNN 188 may generate a first refined pose, process that refined pose to generate a second refined pose, process that second refined pose to generate a third refined pose, and so on for any number of iterations. The number of iterations for pose refinement before outputting a final pose estimate may be preset (e.g., two, three, four, six, etc. iterations) or may be based on a sufficiency test. As an example, the single-view CNN 188 may output a final pose estimate when the difference between the last refined pose estimate parameters and the penultimate refined pose estimate parameters are within a threshold range. An iteratively-refining single-view matching neural network analysis may comprise any number of sequential single-view matching neural network analyses. For example, an iteratively-refining single-view matching neural network analysis may include four sequential analyses via the single-view matching neural network. In some examples, the single-view matching network may indicate that the refinement process is complete when the estimated rotation angle (as estimated by the single-view matching network) is below a threshold angle.

In some examples, a concatenation submodule may concatenate the output of the first fully-connected layer of the multi-view CNN 190. The output of the first fully-connected layer contains encoded pose parameters as a high-dimensional vector. The final fully-connected layer include the rotation and translation layers. The number of layers concatenated by the concatenation submodule corresponds to the number of inputs and network backbones. The initial pose estimate, intermediary pose estimates (e.g., refined pose estimates), and/or the final pose estimate may be expressed or defined as a combination of three-dimensional rotation parameters and three-dimensional translation parameters from the final fully-connected layer of the multi-view CNN 190.

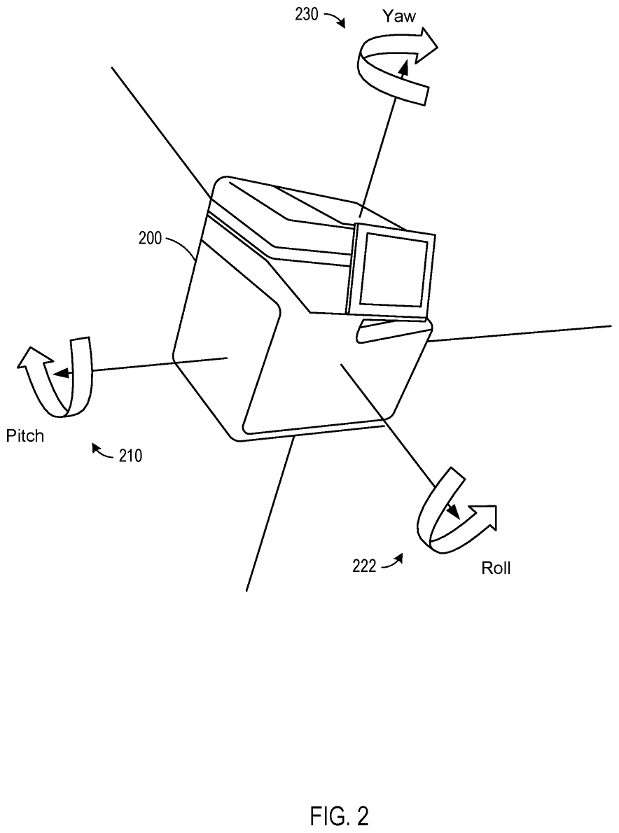

FIG. 2 illustrates an example of an object 200 (a printer) and shows the pitch 210, roll 220, and yaw 230 rotational possibilities of the object 200 in three-dimensional space. It is appreciated that the object 200 may also be translated in three-dimensional space relative to a fixed or arbitrary point of reference.

A digitally rendered view of an object, such as the illustrated view of example object 200, may be used to train a convolutional neural network (e.g., a Mask R-CNN) for object detection and segmentation and/or a single-view network. Similarly, multiple different rendered views of an object may be used to train a multi-view network. In other embodiments, images of actual objects may be used for training the various CNNs.

Training CNNs with objects at varying or even random angle rotations, illumination states, artifacts, focus states, background settings, jitter settings, colorations, and the like can improve accuracy in processing real-world captured images. In some examples, the system may use a first set of rendered images for training and a different set of rendered images testing. Using a printer as an example, a simple rendering approach may be used to obtain printer images and place them on random backgrounds. To improve the performance of the single-view and/or multi-view CNNs, photorealistic images of printers placed inside indoor virtual environments may also be rendered.

To generate a large number of training images, the system may render the printer in random positions and add random backgrounds. The background images may be randomly selected from a Pascal VOC dataset. To mimic real world distortions, the rendering engine or other system module may apply random blurring or sharpening to the image followed by a random color jittering. The segmentation mask may be dilated with a square kernel with a size randomly selected from 0 to 40. The system may apply this dilation to mimic possible errors in the segmentation mask estimated by Mask R-CNN during inference time.

Background images and image distortions may be added during the training process to provide a different set of images at each epoch. To include more variety and avoid overfitting, the system may include three-dimensional models of objects from LINEMOD dataset. This example dataset contains 15 objects, but the system may use fewer than all 15 (e.g., 13).

As an example, the system may render 5,000 training images for each object. The system may utilize the UNREAL Engine to generate photorealistic images and three-dimensional models in photorealistic indoor virtual environments with varying lighting conditions. A virtual camera may be effectively positioned in random positions and locations facing at the printer. Rendered images that result in the printer being highly occluded by other objects or where it is far away from the virtual camera may be discarded. In a specific example, 20,000 images may be generated in two different virtual scenarios. One of the virtual scenarios may be used as a training set and the other virtual scenario may be used as a testing set. In some examples, the system may alternatively or additionally capture real printer images, annotate them, and use them for training and/or testing.

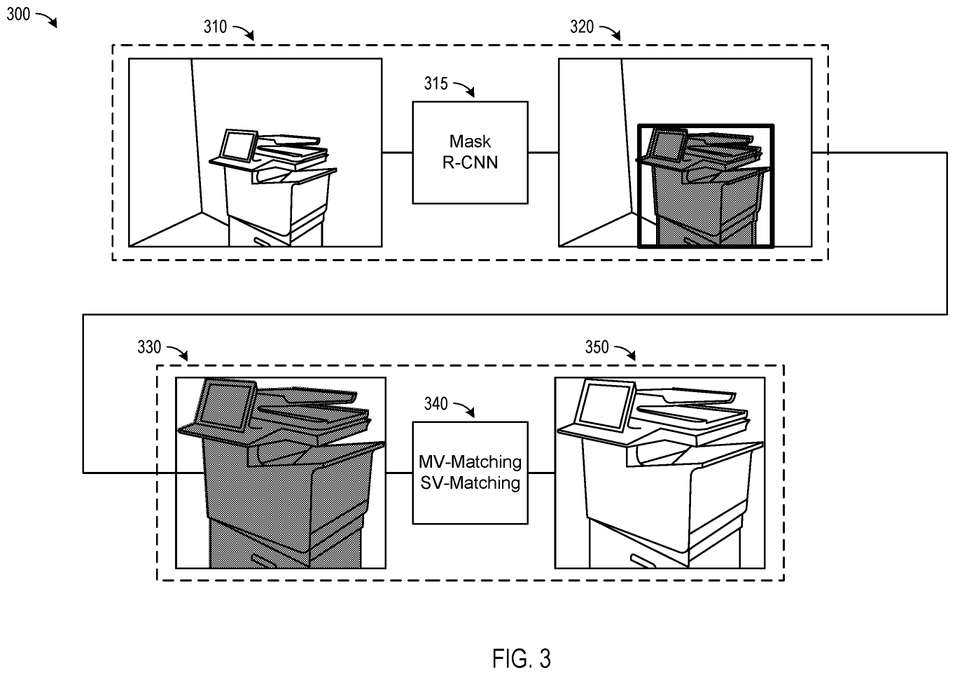

FIG. 3 illustrates a conceptual block diagram 300 of a workflow for pose estimation. A captured image 310 is processed via an object detection and segmentation subsystem, such as Mask R-CNN 315, to detect an object 320. The image of the object 320 may optionally be cropped and/or resized prior to subsequent processing. In the illustrated example, the cropped and resized image of the object 330 is processed via a multi-view CNN followed by iterative single-view CNN processing, at 340. A final pose of the object may be determined, at 350.

In an example using six views for the multi-view CNN, an object detected in a captured image (i.e., “real-world” image) is compared with six corresponding flownets in the multi-view CNN to determine an initial pose estimate. A new image can be rendered based on the initial pose estimate and matched with the input image with the single view matching network. The single-view matching network generates a refined pose estimate. Based on the refined pose estimate of the from the single-view CNN, a render engine generates a refined image rendered. The single-view matching network matches the refined image with the input image to further refine the pose estimate. Iterative processing via the single-view CNN is used to develop a final, fully refined pose estimate.

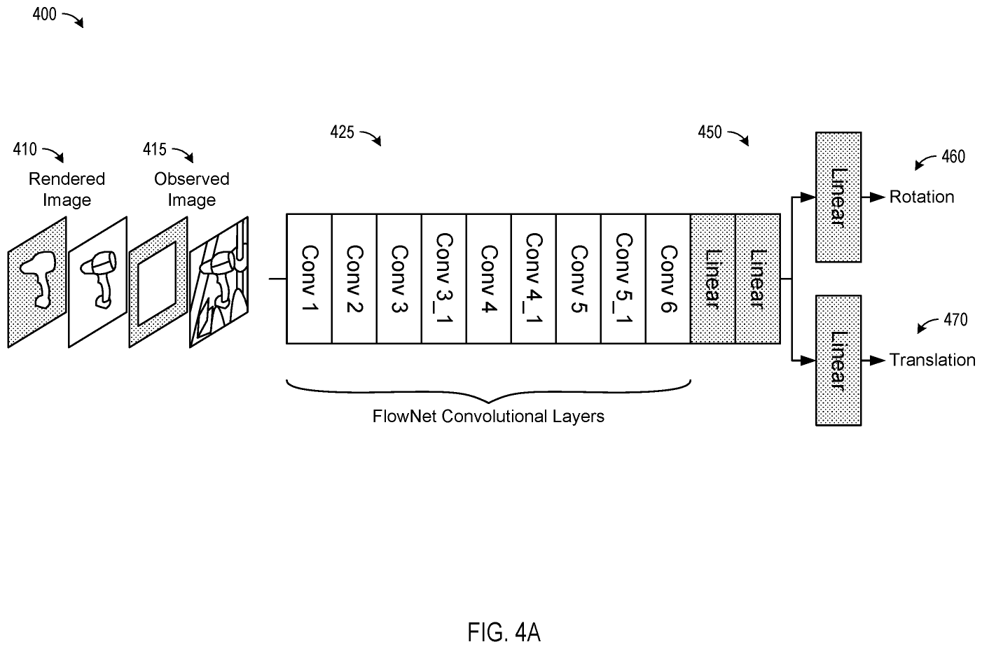

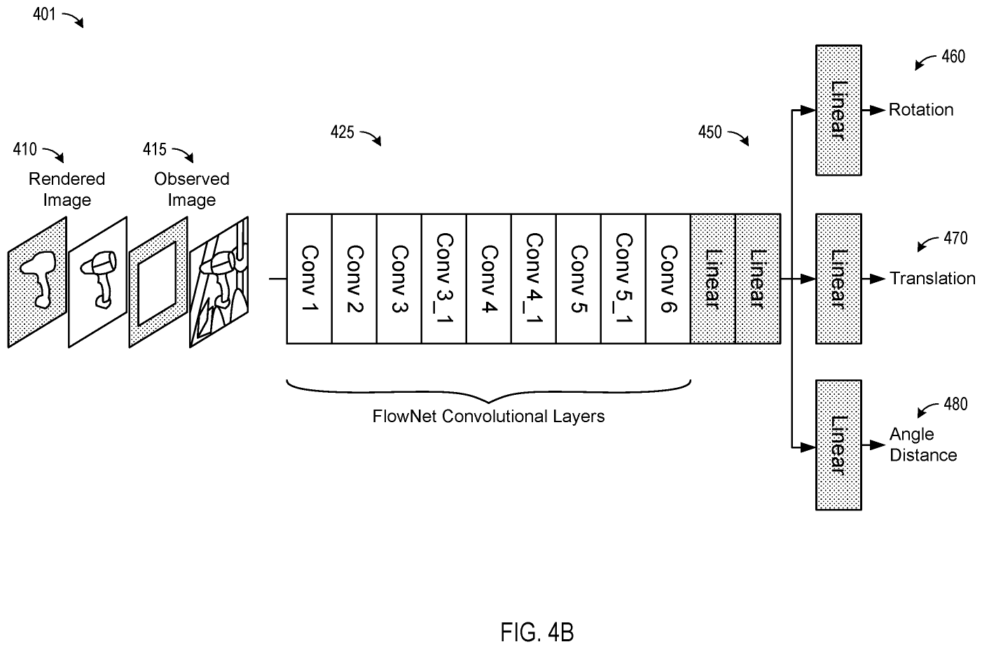

FIG. 4A illustrates an example block diagram 400 of a single-view CNN that processed rendered 410 and observed 415 images through various flownet convolutional layers 425 and linear layers 450 to determine rotation 450 and translation 470 pose parameters between a pair of images. The rendered 410 and observed 415 images might, for example, be 8-bit images with 640×480 resolution. Alternative resolutions and bit-depths may be used.

The single-view CNN may use, for example, flownets such as FlowNetSimple (FlowNetS), FlowNetCorr (FlowNetC) and/or combinations thereof (e.g., in parallel) to process the images. The output of the flownets may be concatenated. After the convolutional layers 425, two fully-connected layers (e.g., of dimension 256) may be appended (e.g., after the 10th convolutional layer of FlowNetS and the 11th convolutional layer of FlowNetC). In some examples, two regressors are added to the fully-connected layers to estimate the rotation parameters 460 and translation parameters 470. In some examples, an extra regressor may be included to estimate an angle distance.

In some examples, one fully-connected output includes three parameters for the translation and four parameters for the rotation. In examples where FlowNetS is used for the flownet convolutional layers 425 and no extra regressor is included to estimate an angle distance, the single-view CNN is an iteratively operated process similar to DeepIM described in “DeepIM: Deep Iterative matching for 6D Pose Estimation” by Y. Li et al. published in the Proceedings of the European Conference on Computer Vision, pp. 883-698, September 2018, Munich, Germany. The single-view CNN, per the example in FIG. 4A, may be trained using a loss function expressed below as Equation 1,

$$L ( p , \hat{p} ) = ‖ 1 - {q}^{T} \frac{\hat{q}}{‖ \hat{q} ‖} ‖ + ‖ t - \hat{t} ‖ + λ ‖ 1 - ‖ \hat{q} \vert \vert ‖ \qquad Equation 1$$

In Equation 1, p=[q|t] and \hat{p}=[\hat{q}|\hat{t}] are the target and estimated rotation quaternion and translation parameters, respectively. The value λ may, for example, be set to 1 or modified to scale the regularization term added to force the network to output a quaternion so ∥\hat{q}∥=1. q^{T} represents the ground-truth quaternion that defines the pose difference of the input image with the unit quaternion (u) expressible as u=[1,0,0,0].

FIG. 46 illustrates an example block diagram 401 of another single-view convolutional neural network that includes various flownet convolutional layers 425 and linear layers to determine rotation 460, translation 470, and angle distance 480 as pose parameters. The single-view CNN, per the example in FIG. 46, may be trained using a modified form of the loss function in Equation 1, expressed below as Equation 2.

$$L ( p , \hat{p} ) = ‖ 1 - {q}^{T} \frac{\hat{q}}{‖ \hat{q} ‖} ‖ + ‖ t - \hat{t} ‖ + λ ‖ 1 - ‖ \hat{q} \vert \vert ‖ + ‖ d - \hat{d} ‖ \qquad Equation 2$$

In Equation 2, p=[q|t] and \hat{p}=[\hat{q}|\hat{t}] are the target and estimated rotation quaternion and translation parameters, respectively. q^{T} represents the ground-truth quaternion that defines the pose difference of the input image with the unit quaternion (u) expressible as U=[1,0,0,0]. The value λ may, for example, be set to 1 or modified to scale the regularization term added to force the network to output a quaternion so ∥\hat{q}∥=1. The distance, d, is equal to 2 cos⁻¹|q^{T}u| and the value, \hat{d}, is the estimated angle distance output by the single-view CNN (angle distance 480 in FIG. 4B).

The angle distance value, \hat{d}, can additionally or alternatively computed by expressing the rotation quaternion as axis-angle representation and using the angle value. The angle distance value will be zero when there is no difference between the poses of input images. The single-view CNN may stupe the pose refinement process when the angle distance value is less than an angle threshold value. The threshold value may be defined differently for different applications requiring differing levels of precision and accuracy.

For example, if the estimated angle distance value is less than an angle distance threshold of 5°, the system may stop the pose refinement process. If the angle distance is determined to be greater than the threshold value (in this example, 5°), then the iterative single-view CNN process may continue. In some instances, setting the threshold value to a non-zero value avoids jittering or oscillation of pose estimates around the actual pose of an object in a captured image.

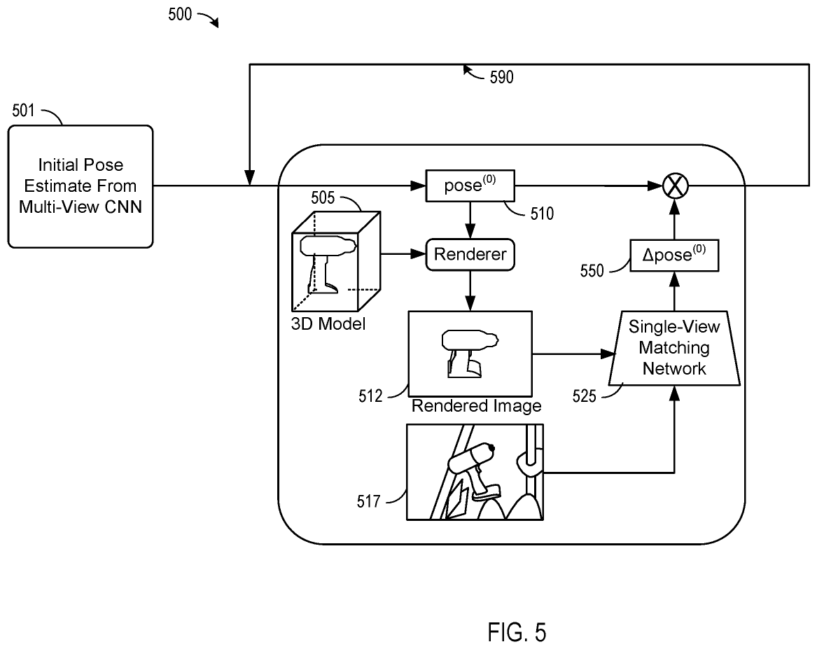

FIG. 5 illustrates a block diagram 500 of an example workflow that, includes the single-view CNN 525. The workflow starts with an initial pose estimate of an object from the multi-view CNN 501. A three-dimensional model 505 of the object and the most recent pose estimate 510 are used to generate a rendered image 512 of the object. As previously noted, the initial pose estimate 501 from the multi-view CNN is used for the first iteration.

The rendered image 512 from the captured image 517 (also referred to as a target image or observed image) are provided as the two input images to the single-view CNN 525 for comparison. The trained single-view CNN 525 determines a pose difference 550 between the rendered image 512 of the object and the object in the captured image 517. The single-view CNN 525 may include, for example, flownets, fully-connected layers, and regressors, as described herein.

The initial pose 510 is modified by the determined pose difference 550 for subsequent, iterative processing (iterative feedback line 590). In some example, the pose estimate is refined via a fixed number of iterations between two and six iterations. In other examples, the single-view matching network may indicate that the refinement process is complete when the estimated rotation angle (as estimated by the single-view matching network) is below a threshold angle.

The single-view CNN may incorporate, for example, FlowNetS, FlowNetCorr, and both in parallel. The single-view CNN may share most of its weights with the multi-view CNN used to determine the initial pose estimate. In some example, the single-view CNN may omit segmentation and optical flow estimation analyses that are included in DeepIM.

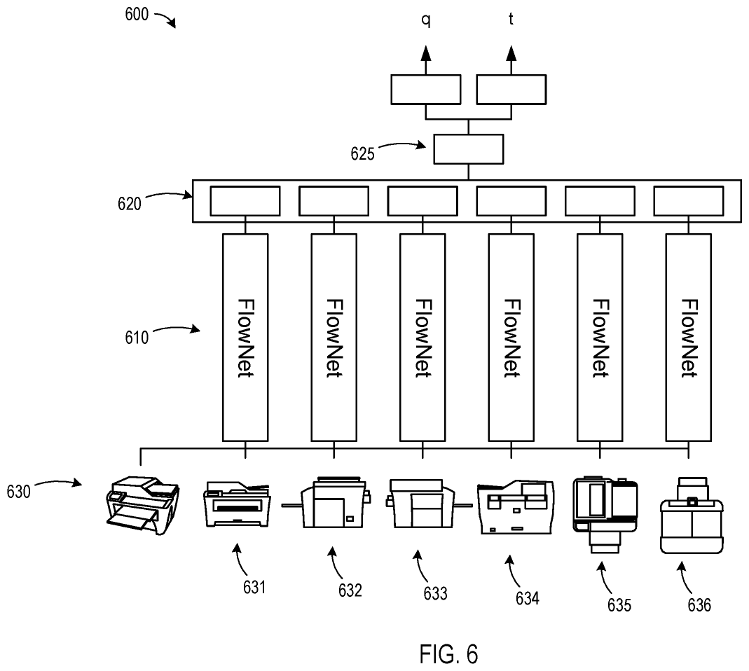

FIG. 6 illustrates a block diagram 600 of a multi-view CNN in which six flownets 610 are trained based on six views 631-636 of an object 630. Each flownet of the multi-view CNN has one of the views as an input concatenated with the input image. In some example, the views are digitally rendered at various angles. In other examples, it is possible that the views are obtained using captured images of a real object at various angles/perspectives. The flownets 610 may be concatenated 620 and combined 625 to determine an initial pose defined by q and t parameters for the rotation pose parameters and translation pose parameters, respectively. In some examples, an object detected in an image is processed in parallel through the six flownets 610 to determine the initial pose estimate.

In one example, the input to the multi-view CNN is a detected object within a captured image. The detected object may be electronically input as a set of tensors with 8 channels. Specifically, each flownet 610 may be provided as input the RGB image as three channels, its segmentation mask as 1 channel, a rendered image as 3 channels, and the rendered image segmentation mask as 1 channel.

The illustrated example shows six flownets corresponding to six views. However, alternative examples may utilize fewer flownets based on a fewer number of views or more flownets based on a greater number of views. In some example, the views used for unique flownets may be at different angles and/or from different distances to provide different perspectives. Accordingly, the various examples of multi-view flownet CNN allow for an initial pose estimate in a class-agnostic manner and many of the weights of the multi-view flownet CNN are shared with those of the single-view flownet CNN.

While the loss functions expressed in Equations 1 and 2 above can be used for training the multi-view CNN. However, p=[q|t] and \hat{p}=[\hat{q}|\hat{t}] do not define the target and estimated pose difference between a pair of images, but rather the “absolute” or reference pose of the object. In various examples, the output q and t parameters defining an initial pose estimate are provided to the single-view CNN (e.g., 501 in FIG. 5) for iterative refinement to determine a final pose estimate of the object that may include q, t, and optionally d pose parameters.

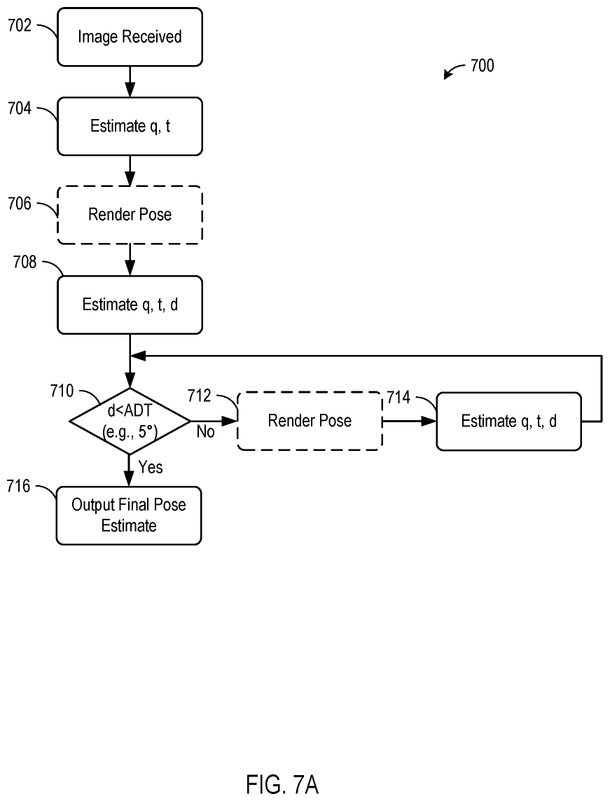

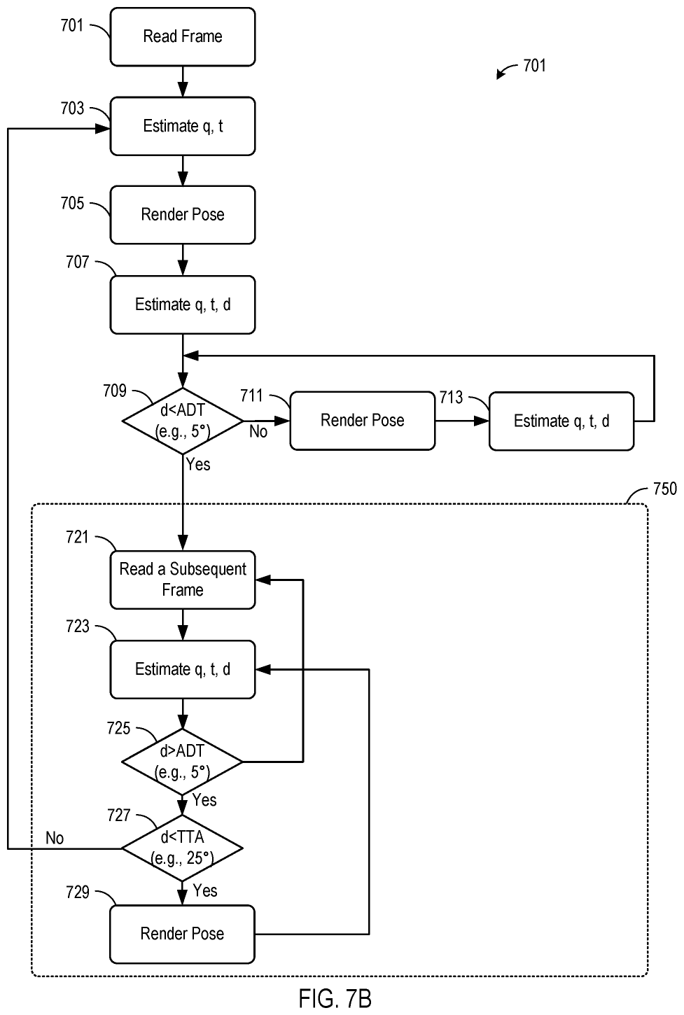

FIG. 7A illustrates a flow diagram 700 of an example workflow for pose estimation. An image is received, at 702, and pose parameters q and t are estimated, at 704, via a multi-view CNN as described herein. A rendering engine may render a pose, at 706. A single-view CNN may estimate q, t, and d parameters, at 708, as described herein. If the angle distance parameter, d, is less than an angle distance threshold (ADT), at 710, a final pose estimate is output, at 716. For example, the ADT may be set at 5°, as illustrated in FIG. 7A. The ADT may be set lower or higher depending on a target accuracy level for a particular application or usage scenario.

As illustrated, if the angle distance, d, is greater than the ADT (e.g., 5°), then a new pose may be rendered, at 712, and the single-view CNN may iteratively generate new, refined q, t, and d parameters, at 714, for further comparison with the ADT, at 710, until a final pose estimate is output, at 716. Rendering a pose, at 706 and 712, is shown in dashed lines to indicate that rendering may be performed by a rendering engine integral to the pose estimation system. In other embodiments, rendering a pose, at 706 and 712, may be implemented via a separate rendering engine external to the pose estimation system described herein.

FIG. 7B illustrates a flow diagram 701 of an example workflow for pose estimation and tracking. A frame is read, at 701, and pose parameters q and t are estimated, at 703, via a multi-view CNN as described herein. A rendering engine may render a pose, at 705. A single-view CNN may estimate q, t, and d parameters, at 707, as described herein. If the angle distance parameter, d, is less than an angle distance threshold (ADT), at 709, a final pose estimate is output. For example, the ADT may be set at 5°. The ADT may be set lower or higher depending on a target accuracy level for a particular application or usage scenario.

As illustrated, if the angle distance, d, is greater than the ADT (e.g., 5°), then a new pose may be rendered, at 711, and the single-view CNN may iteratively generate new, refined q, t, and d parameters, at 713, for further comparison with the ADT, at 709.

A final pose estimate output, at 709, with an angle distance less than the ADT, is used. For pose tracking 750, a subsequent frame is read, at 721, and the single-view CNN may estimate q, t, and d parameters (e.g., through an iteratively refining process as described herein), at 723. The subsequent frame may be the very next frame captured by a video camera or still-image camera. In other examples, the subsequent frame may be frame that is some integer number of frames after the most recently analyzed frame. For example, every 15^{th}, 30^{th}, or 60^{th} frame may be analyzed for pose tracking.

If the angle distance is less than the ADT, at 725, then the pose has not significantly changed and a subsequent frame is read, at 721. Once a frame is read, at 721, and the single-view CNN 723 estimates an angle distance, d, at 725, that exceeds the ADT, then the pose is determined to have changed. For continued pose tracking 750, a new pose is rendered, at 729, for further analysis via the single-view CNN 723, if the angle distance, d, is less than the threshold training angle (TTA) shown as an example 25°. If the angle distance, d, is greater than the TTA, then the multi-view CNN is used to estimate a new initial pose, at 703, and the process continues as described above and illustrated in FIG. 7.

Images captured using an imaging system (e.g., a camera) are referred to herein and in the related literature as “real” images, target images, or captured images. These captured images, along with rendered or computer-generated images may be stored temporarily or permanently in a data storage. The terms data storage and memory may be used interchangeably and include any of a wide variety of computer-readable media. Examples of data storage include hard disk drives, solid state storage devices, tape drives, and the like. Data storage systems may make use of processors, random access memory (RAM), read-only memory (ROM), cloud-based digital storage, local digital storage, network communication, and other computing systems.

Various modules, systems, and subsystems are described herein as implementing or more functions and/or as performing one or more actions or steps. In many instances, modules, systems, and subsystems may be divided into sub-modules, subsystems, or even as sub-portions of subsystems. Modules, systems, and subsystems may be implemented in hardware, software, hardware, and/or combinations thereof.

Specific examples of the disclosure are described above and illustrated in the figures. It is, however, appreciated that many adaptations and modifications can be made to the specific configurations and components detailed above. In some cases, well-known features, structures, and/or operations are not shown or described in detail. Furthermore, the described features, structures, or operations may be combined in any suitable manner in one or more examples. It is also appreciated that the components of the examples as generally described, and as described in conjunction with the figures herein, can be arranged and designed in a wide variety of different configurations. Thus, all feasible permutations and combinations of examples are contemplated. Furthermore, it is appreciated that changes may be made to the details of the above-described examples without departing from the underlying principles thereof.

In the description above, various features are sometimes grouped together in a single example, figure, or description thereof for the purpose of streamlining the disclosure. This method of disclosure, however, is not to be interpreted as reflecting an intention that any claim now presented or presented in the future requires more features than those expressly recited in that claim. Rather, it is appreciated that inventive aspects lie in a combination of fewer than all features of any single foregoing disclosed example. The claims are hereby expressly incorporated into this Detailed Description, with each claim standing on its own as a separate example. This disclosure includes all permutations and combinations of the independent claims with their dependent claims.

What is claimed is:

1. A pose estimation system, comprising:
a processor; and
a computer-readable medium with instructions stored thereon that, when implemented by processor, cause the pose estimation system to perform operations for estimating a pose of an object in a target image, the operations comprising:
matching the target image through a unique network for each view of a multi-view matching neural network,
determining an initial pose estimate based on the multi-view matching neural network matching, and
reporting a final pose estimate of the object via an iteratively-refining single-view matching neural network analysis.

2. The system of claim 1, wherein the multi-view matching neural network comprises six unique networks for each of: a frontal view, a first lateral view, an opposing lateral view, a top view, a bottom view, and a back view.

3. The system of claim 1, wherein the single-view matching neural network is configured to iteratively refine the initial pose to determine the final pose with four sequential single-view matching neural network analyses.

4. A system, comprising:
a multi-view matching subsystem to generate an initial pose estimate of an object in a target image, wherein the multi-view matching subsystem includes:
a network for each object view of the multi-view matching subsystem to estimate pose parameters based on a comparison of the target image with each respective object view,
a concatenation layer to concatenate the estimated pose parameters of each network, and
an initial pose estimator to generate an initial pose estimate based on the concatenated estimated pose parameters; and
a single-view matching neural network to:
receive the initial pose estimate from the multi-view matching subsystem, and
iteratively determine a final pose estimate of the object in the target image.

5. The system of claim 4, wherein the multi-view matching subsystem comprises six networks for each of six object views.

6. The system of claim 5, wherein the six object views comprise a frontal view, a first lateral view, an opposing lateral view, a top view, a bottom view, and a back view.

7. The system of claim 4, wherein the final pose estimate is expressed as a combination of three-dimensional rotation parameters and three-dimensional translation parameters.

8. The system of claim 4, wherein the single-view matching neural network is configured to iteratively refine the initial pose to determine the final pose with two sequential single-view matching neural network analyses.

9. The system of claim 4, wherein the single-view matching neural network is configured to iteratively refine the initial pose through intermediary pose estimates to determine the final pose estimate once a difference between two most recent intermediary pose estimates is less than a threshold difference amount.

10. The system of claim 4, wherein the multi-view matching subsystem and the single-view matching neural network share multiple neural network parameters.

11. A method, comprising:
receiving an image of an object;
determining a first pose estimate of the object via a multi-view matching neural network; and
determining a final pose estimate of the object via analysis by an iteratively-refining single-view matching neural network.

12. The method of claim 11, wherein the iteratively-refining single-view matching neural network analysis comprises two sequential single-view matching neural network analyses.

13. The method of claim 11, wherein the iteratively-refining single-view matching neural network analysis comprises a number, N, of sequential single-view matching neural network analyses, where the number N is a fixed integer.

14. The method of claim 11, wherein the iteratively-refining single-view matching neural network analysis is repeated until a difference between two most recent outputs of the single-view matching neural network is less than a threshold difference amount.

15. The method of claim 11, wherein the multi-view matching neural network and the single-view matching neural network share multiple neural network parameters.
